(19) United States
(12) Patent Application Publication
(10) Pub. No.: US 2006/0010792 A1
(43) Pub. Date: Jan. 19, 2006

(54) Storm shutter apparatus

(76) Inventor: Douglas W. Biggers, Key Biscayne, FL (US)

Correspondence Address: Robert J. Van Der Wall;Colonial Bank Centre, Suite 1620, 1200 Brickell Avenue, Miami, FL, 33131, US

(21) Appl. No.: 10/893,713

(22) Filed: Jul. 19, 2004

(51) Int. Cl. E06B 3/26

(52) U.S. Cl. 52/202

(57) ABSTRACT

Disclosed is storm shutter apparatus for protecting building apertures such as door and window openings from hurricanes, wind-blown debris, gales, rain, and vandals using very low cost, low profile extrusion brackets designed specifically for installation during original building construction in combination with a variety of conventional manufactured windows, hinged doors or sliding glass doors in conventional building structures, and the use of those brackets with very low cost adjustable, lightweight isosceles trapezoidal corrugated panels. The first objective is to render building apertures compliant with the International Building Code (“I.B.C.”) even though they are constructed with conventional fenestration products unmodified for I.B.C. compliance. Another objective is to accomplish the foregoing without the expense of separate labor costs for the installation of hurricane shutters and without the expense of purchasing fenestration products modified for I.B.C. compliance.

### BACKGROUND OF THE INVENTION

1. Field of the Invention

The present invention generally relates to the field of protecting building apertures such as door and window openings from hurricanes, wind-blown debris, gales, rain, and vandals. More specifically it concerns very low cost, low profile extrusion brackets designed specifically for installation during original building construction in combination with a variety of conventional manufactured windows, and hinged or sliding glass doors in conventional building structures, and the use of those brackets with adjustable, lightweight isosceles trapezoidal corrugated panels for protection. The goal is to render building apertures compliant with the International Building Code (“I.B.C.”) even though those building apertures employ fenestration products that are unmodified for I.B.C. compliance.

2. Description of the Prior Art

Investigations of damage from major hurricanes such as Hurricane Andrew indicate that most of the damage to a residence structure is from the wind and wind borne missiles that break windows and allow rain and wind into the structure. In south Florida, where Hurricane Andrew caused unprecedented destruction, nearly all residential structures are masonry, cinder block structures with wooden gable ends and roofs. Once the wind reaches the interior of such structures, the resulting pressure tends to blow out the windows, gable ends and/or lift the roof off the structure. This is due in part to the Bernoulli effect, where wind blowing around and over a building causes lower pressure than the high pressure air inside, and sucks out a window, gable end, or roof. Just as an airplane rises due to the pressure differential of faster air moving over a wing to create a low pressure, compared to the high pressure of slower moving air under a wing, so too do the weakest structures in a home tend to be blown out due to the Bernoulli effects of wind blowing around and over the building. Of course, window and door shutters of adequate design can help keep the wind and rain from entering a home during a hurricane or strong storm.

Historically, upon the approach of a hurricane many homeowners have nailed plywood sheets over building apertures seeking to prevent wind-driven rain and debris from breaking into the structure's interior. Nailing sheets of plywood over every building aperture is difficult on many homes, and can take too much time to complete before the storm hits. Moreover, many homeowners are reluctant to drive nails into their window frames or do not want to be on a ladder during high winds. An individual has difficulty in holding up a large, heavy piece of plywood and nailing it in at the same time, especially as the wind velocity increases. In addition, when a hurricane approaches, building suppliers almost invariably run out of plywood.

As a result of recent hurricanes making landfall and devastating numerous structures, especially as Hurricane Andrew did, many building codes were found to be inadequate to protect structures and their occupants. Multiple state and federal agencies came together with a uniform goal to standardize building methods. Specifically, the merger of the Southern Building Code Congress International (SBCCI) with both the Building Officials and Code Administrators (BOCA) and the International Conference of Building Officials (ICBO) resulted in the International Code Council (ICC). The ICC has created a series of uniform international building codes including one that applies to residential structures, which will be referred to in this document as the International Building Code (“I.B.C.”). Accordingly, reference to the I.B.C. hereinafter specifically means compliance with the hurricane protection aspects of the I.B.C. for residential structures.

The first state to adopt this new I.B.C., in 2002, was Florida which was shortly followed by North Carolina. The code specifically required hurricane protection for all residential structures within a certain distance of coastal waters.

The economic impact of the new code on fenestration products was the cause of the present invention. One of its prominent features is that it allows fenestration manufacturers to continue production of their products with little or no structural design changes while compliance with the I.B.C. can still be achieved. A builder who is installing a window, door or sliding glass door is required under the I.B.C. to have impact protective apparatus protecting the glazed (glass covered) building apertures. The builder or installer of the window can place the inventive brackets on the window prior to installation and then secure hurricane protection panels to the exterior side of the window without interfering or changing the design of the window. Other advantages are: consolidating products prior to installation reduces labor costs, providing a user friendly easily installed shutter, installation can be within the opening of the building's structure with masonry structures and in such instances does not extend beyond such opening, there's no need for screws or bolts, headers or sills to be fastened to the exterior surface of a building, with this combination system decorative or ornamental designs can once again be placed around the window's perimeter, and the use of the brackets actually strengthens the fenestration products.

There is a great profusion of prior art in this field. Most of it relates to hurricane and storm shutters that are applied to building apertures after the building is constructed, and virtually all of it deals with the masonry structures common only to South Florida, and not the wood frame structures that predominate the entire rest of the United States.

A first example is Hill, U.S. Pat. No. 5,487,244, for a shutter system with a downwardly facing channel bolted to the exterior of the structure as a header and using an angle iron sill in combination with isosceles trapezoidal corrugated panels disposed between the header and the sill to protect the building aperture. A very similar reference is Poirier, U.S. Pat. No. 6,209,263, which also employs a downwardly facing channel as a header and an angle iron sill between which are disposed isosceles trapezoidal corrugated panels. Another example is DiVeroli, U.S. Pat. No. 6,189,264, which discloses a storm shutter system capable of being installed from the interior of the structure through the building aperture and which uses an upwardly facing channel at the sill and either downwardly facing channel as a header or a bracket, in each case being attached to the exterior of the building. Other examples are Knezevich, et al., U.S. Pat. Nos. 6,021,839 and 6,122,868, which use other complex extrusions at the header and the sill which extrusions are bolted to the exterior of a structure. A further example is Thompson, et al., U.S. Pat. No. 6,205,713 which uses brackets attached to the exterior of the structure.

A number of the prior art references include exterior frames and utilize louvers to cover the building aperture. Examples are Horn et al., Patent Application Publication No. U.S. 2002/0056230 A1 and Biggers, U.S. Pat. No. 6,148,895. Some of the references employ complex structures such as Mullet et al., U.S. Pat. No. 6,341,639. See, for example, the elaborate extrusions shown in FIG. 13 thereof. Also see FIGS. 35-39A thereof. Another example of a reference having exceptionally complex extrusions is Fullwood, U.S. Pat. No. 5,857,298. See, for example, FIGS. 3-5, 7-10, 12-15, 17-20, and especially FIG. 28.

As will be more fully seen hereinafter, the present invention includes headers and sills that are simple extrusions intended to be installed at the time of original building construction to produce in combination with isosceles trapezoidal corrugated panels a very unobtrusive, very simple, and very inexpensive hurricane shutter. While the present invention differs from the overwhelming majority of the profusion of prior art that is intended for installation after construction of the building is complete, the prior art is not devoid of references teaching storm shutters intended to be installed as part of original building construction. Examples are Fullwood, U.S. Pat. Nos. 5,857,298 and 5,941,031, and Biggers, U.S. Pat. No. 5,540,018. Biggers '018 adopts the same notions of the present invention of having brackets installed with windows at the time of original building construction to save time and money and using isosceles trapezoidal corrugated panels with the brackets, but the extrusions are much more complex than those featured in the present invention, making them much more expensive, and sacrificing the goal of the present invention in which the conventional fenestration products require little or no modification to be compatible with the brackets used for the hurricane shutters. See, for example, FIGS. 6-11, and 13-17.

### SUMMARY OF THE INVENTION

Bearing in mind the foregoing, it is a principal object of the present invention to provide a hurricane shutter apparatus for installation in a building at the time of its original construction that will result in compliance with the International Building Code (“I.B.C.”) using conventional fenestration products in combination with simple, inexpensive extrusions as header and sill brackets to support in storm conditions simple, inexpensive isosceles trapezoidal corrugated panels.

It is a related principal object of the invention to enable the reduction of labor costs in constructing I.B.C. compliant structures using conventional fenestration products by combining simple, inexpensive extrusions with those conventional products prior to installation of the combinations in building apertures during original construction.

Another related object of the invention is to achieve the installation of hurricane shutter supporting brackets for I.B.C. compliant structures that use conventional fenestration products without attaching those brackets using screws or bolts on the exterior surface of a building or where the brackets are exterior to the building.

An additional object of the invention is to install at original building construction header and sill brackets for use with conventional fenestration products in a I.B.C. compliant building that is completely disposed within a conventionally sized building aperture such that decorative or ornamental designs can once again be placed around the window's perimeter.

A further object of the invention is to provide a user friendly easily installed shutter which does not extend beyond the building aperture in the case of masonry structures.

A related principal object of the invention is to employ such headers and sills that are of simple, low profile design.

A further object of the invention is to provide such header and sill extrusions that accommodate both buildings constructed from masonry with conventional flange windows, and buildings constructed with wood frames having conventional fin windows.

Another object of the invention is to provide a hurricane shutter apparatus that has a minimum profile designed to have the least effect on the appearance of the building and the building apertures when not in use.

A further object of the invention is to provide a hurricane shutter apparatus that has been tested as a large missile impact protective system in accordance with the I.B.C. and the Florida Building Code 2001 Nonhigh Velocity Hurricane Zones, and further has been tested for Large Missile Impact Resistance in conformance with ASTM-E 1886-97, 1996-99 and for uniform load structural test ASTM E-330.

Another object of the invention is the use of strong and inexpensive isosceles trapezoidal corrugated panels that are small, lightweight, and easy to install even in windy conditions, and which take up minimal storage space as the panels nest one into the other.

A further object of the invention it is to utilize a header, which when installed during original building construction in a wood frame structure directs water from rain against the side of the building away from the window even when the shutter panels are not in use.

An additional object of the invention is to employ header and sill extrusion designs that provide adequate spacing away from fenestration products for the installation of isosceles trapezoidal corrugated panels.

One more object of the invention is to utilize a sill that employs a recessed slide bolt track that is unobtrusive and has no projecting parts to create a tripping hazard when used with a building aperture furnishing ingress and egress from the building.

A further object of the invention is to provide with wood frame residential structures a rain hood or watershed with a header bracket that is embedded in the wall and that forces water away from the window to prevent leakage, mildew and rot.

Another object of the invention is to strenghen fenestration products by the application of the inventive brackets.

Other objects and advantages will become apparent to those skilled in the art upon reference to the following descriptions and the appended drawings.

In accordance with a principal aspect of the invention there are provided two pairs of brackets for installation at the time of original building construction. The first pair are designed to be a header and sill with wood frame buildings and fin windows such are in use in most of the United States, except South Florida. As noted above, the prior art appears devoid of references that teach hurricane shutters for wood frame residential structures. The second pair are designed to be a header and sill with masonry buildings and flange windows such as are in almost unanimous usage in South Florida. In the following descriptions of the inventive brackets, the terms “inwardly” and “inside” refer to a direction toward the interior of the building on which the brackets are installed during original construction. The terms “outwardly” and “outside” refer to a direction toward the exterior of the building.

The first header bracket is comprised of a downwardly facing channel having a channel web, inner channel flange and outer channel flange. The lower edge of the outer channel flange includes a flare. The channel web is co-planar with a horizontal inwardly projecting arm. Co-planar with the inwardly projecting arm inside of the inner channel flange is disposed a window element web. That terminates with a downwardly depending window element flange. The window element flange outer surface is a contact point for a first window element known as a window flange. The window element web doubles as a spacer between the window and where the corrugated panels are inserted into the downwardly facing channel. On the inside of the window element flange and co-planar with the horizontal inwardly projecting arm is a horizontal window depth spanner. The window depth spanner forms a space between the first window element and a second window element described below. At the inside edge of the window depth spanner and disposed at right angles thereto is a vertical arm. Finally, the vertical arm is at right angles to a window element ridge inside the top edge of the vertical arm. This provides for a window element recess for insertion of the second window element, a window fin, such as already exists with conventional fin windows, which are used in wood frame residential structures throughout the United States.

The first sill bracket is comprised of a recessed bolt head track body containing a recessed bolt head track with a vertical track aperture, vertical track upper face, and vertical track lower face. At right angles to the top of the upper track face is a horizontal track body top. It serves as a resting point for a first window element, the window flange. The horizontal track body top also doubles as a spacer between the window and where the corrugated panels are bolted to the recessed bolt head track body. At the inside edge of the track body top and at right angles thereto is a vertical window depth spanner wall. At the top edge of the window depth spanner wall and at right angles thereto is a horizontal window depth spanner. At the inside edge of the window depth spanner is a vertical downwardly projecting arm. At the bottom of the downwardly projecting arm is an inwardly oriented window element ridge, which creates a window element recess between the downwardly projecting arm and the building structure for the insertion of a second window element, a window fin, such as already exists with conventional fin windows.

The second header bracket is comprised of a downwardly facing channel having a channel web, inner channel flange and outer channel flange. The lower edge of the outer channel flange includes a flare. The channel web is co-planar with a horizontal inwardly projecting arm to interface with the building structure. On the inside of the inner channel flange and part way down the inner channel flange is a horizontal spacer web. At the inside of the spacer web is a downwardly depending window element wall. Co-planar with the spacer web and inside of the window element wall is a window element ridge. The window element ridge creates a window element recess between the building and the window element wall for the insertion of a window element, a window flange, such as already exists with conventional flange windows.

The second sill bracket is comprised of a recessed bolt head track body containing a recessed bolt head track with a track aperture, track upper face, and track lower face. Co-planar with the track lower face is a horizontal inwardly projecting arm to interface with the building structure. Disposed inwardly from the bolt head track is a vertical window element receiving slot for the insertion of a window element such as already exists with conventional flange windows. The slot is formed between the recessed bolt head track body and a parallel vertical slot wall. Co-planar with the slot wall and depending vertically downwardly from beneath the horizontal plane of the inwardly projecting arm is the downwardly projecting arm. At the bottom of the downwardly projecting arm is a base member having a stucco ground ridge.

In accordance with a secondary aspect of the invention, there are provided a plurality of isosceles trapezoidal corrugated panels and wingnut bolts. The panels are to be disposed between the header and sill brackets when a hurricane or other storm threatens, and bolted firmly in place using the bolt heads disposed in the recessed track of the sill bracket, the bolts' shafts disposed through perforations in the lower ends of the panels, and tightened in place using the wingnuts.

The panels when examined in a top or bottom view show most corrugations are conventionally sized, but with one lateral edge corrugation on each panel having a greater width than the conventionally sized corrugations. This results in the ability to laterally adjust the panels' positions with respect to each other and thus adjust the width of the building aperture to be covered.

In accordance with a tertiary aspect of the invention, there are provided a plurality of alternate embodiment brackets that will be described in similar terms to the foregoing in the Detailed

### DESCRIPTION OF THE PREFERRED EMBODIMENTS

In accordance with a final aspect of the invention, the installation of the header bracket in a wood frame residential structure at the time of its construction leads to substantial unexpected advantages to the resistance of the structure and fin windows to conventional rain. A fin window (the type employed with wood frame residential structures) is attached the building aperture by having its fins fastened to the substrate of the wall surrounding the building aperture through a vapor barrier. The substrate is the material that is nailed to the studs that are inside every wood frame wall, the substrate frequently being plywood. The vapor barrier is applied over the substrate, and is usually polyethylene sheeting. Since the fins on a fin window are roughly half way through the thickness of the window frame, the outer half of the window frame is outside of the substrate and vapor barrier, and the channel around the outside of the frame that is outside of the substrate and vapor barrier is a candidate for the collection of rain water, even though the building's facing such as shingles, faux brick, aluminum or wood siding, etc. is applied on top of the vapor barrier. When rain water accumulates in this channel, it can access the window itself through screw holes in the window frame. But when the header bracket used with wood frame buildings is installed with the fin window, its window element ridge is pressed tightly against and sealed to the vapor barrier preventing any water from reaching the window. Sealing is accomplished using seam seal tape or the like. The downwardly facing channel web of the header bracket then forces rain water away from the top of the window, acting as a rain hood or watershed.

In terms of the method of construction and installation of the header bracket and window, the wall is constructed of studs with the substrate then applied thereto. Vapor barrier is then applied over the substrate and taped into the window apertures. The header bracket is combined with the fin window and both are attached to the substrate through the vapor barrier. Both are then sealed to the vapor barrier using seam seal tape or the like. Attaching the header bracket to the substrate and then sealing prevents any water from reaching the window frame, with all water being forced away from the top of the window by the downwardly facing channel web and outer flange. In effect the header bracket is embedded into the wall to provide complete rain hood or watershed protection to the fin window. This is vitally important to prevent eventual leakage, mildew and rot.

### BRIEF DESCRIPTION OF THE DRAWINGS

Various other objects, advantages, and features of the invention will become apparent to those skill in the art from the following discussion taken in conjunction with the appended drawings, in which:

FIG. 1 is a perspective view of a building under construction having six building apertures, five windows and one hinged door. Two windows ready for installation with the header and sill brackets in place on the window. Two windows are shown installed with the header and sill brackets in place. One window is shown installed with hurricane shutter panels in place to protect the building aperture.

FIG. 2 is an exploded perspective view of header and sill brackets above and below a typical window with partial paneling to the right side of the window.

FIG. 3 is a perspective view of a building having six building apertures, four windows, one hinged door and one sliding glass door, all of which are covered with the inventive hurricane shutter apparatus. All the building apertures are protected by the preferred embodiment of a header and a sill bracket equipped with vertically disposed isosceles trapezoidal corrugated panels. The sliding glass door is protected with alternative embodiment vertical brackets with horizontal hurricane protection storm panels. One hinged door uses an alternative embodiment exterior wall mounted header and sill supporting the isosceles trapezoidal corrugated panels.

FIG. 4 is an exploded perspective view of a typical sliding glass door with vertical brackets to be attached to the sliding glass door jambs, with partial paneling beneath the sliding glass door.

FIG. 5 is a perspective view of a first header bracket with a downwardly facing channel providing a location for the placement of the top ends of hurricane protection panels. The bracket includes a spacer to form a space between the window and where the corrugated panels are inserted into the downwardly facing channel. On the inside of the spacer is a window element groove for the insertion of a first window element such as already exists with conventional fin windows. At the inside edge of the window element web and disposed at right angles thereto is a vertical arm that interfaces with the building structure. Finally, bracket includes a window element recess for insertion of a second window element such as already exists with conventional fin windows.

FIG. 6 is a perspective view of a first sill bracket with a recessed bolt head track. Disposed inwardly from the bolt head track is a spacer. Disposed inwardly from the spacer is a vertical downwardly projecting arm to interface with the building structure. At the bottom of the downwardly projecting arm is an inwardly oriented window element ridge, which creates a window element recess between the downwardly projecting arm and the building structure for the insertion of a window element such as already exists with conventional fin windows.

FIG. 7 is an exploded view of the brackets of FIGS. 18 and 19 with a conventional fin window and with a hurricane shutter panel in proximity to its installation position and with a typical bolt and wingnut used to secure the panel upon installation to the sill bracket.

FIG. 8 is an assembly drawing showing the elements of FIG. 7 completely assembled on a wood frame building.

FIG. 9 is an exploded bottom view of a sill bracket and hurricane protection storm panels in proximity thereto.

FIG. 9A is a broken back elevation view of the bottom edge of a single hurricane protection storm panel showing how it is perforated for insertion of bolts with a slot for the adjustment of the lateral position of the adjoining panel to accommodate different building aperture widths.

FIG. 10 is a perspective view of a second header bracket with a downwardly facing channel providing a location for the placement of the top ends of hurricane protection panels and with an interior inwardly projecting arm to interface with the building structure. The bracket includes several elements which together form a space between the window and where the corrugated panels are inserted into the downwardly facing channel. On the inside of the bracket is a recess for placement of a flange window element such as already exists with conventional flange windows.

FIG. 11 is an exploded perspective view of a second sill bracket with a recessed bolt head track and a horizontal inwardly projecting arm to interface with the building structure. Disposed inwardly from the bolt head track is a vertical window element receiving slot for the insertion of a window element such as already exists with conventional flange windows. A bolt such as used in the track and accompanying wingnut are illustrated in proximity to and alignment with the track.

FIG. 12 is an exploded view of the brackets of FIGS. 10 and 11 with a conventional flange window and with a hurricane shutter panel in proximity to its installation position and with a typical bolt and wingnut used to secure the panel upon installation to the sill bracket.

FIG. 13 is an assembly drawing showing the elements of FIG. 12 completely assembled in a masonry building aperture.

FIG. 14 is an exploded perspective view of an alternative embodiment sill bracket for use with a sliding or roller window, but it lacks the recessed bolt head track of the first and second sill brackets. It includes a horizontal flat track at its top to interface with the frame of the window, from the outside edge of which depends downwardly a vertical member. The vertical member is perforated by one of a plurality of bolts pointing horizontally outward threaded through the vertical member. These receive wingnuts, one of which is shown in axial proximity to the bolt. The nuts and bolts attach isosceles trapezoidal panels to the third sill bracket. At the lower edge of the vertical member is an outwardly facing channel in which can be disposed the heads of screws for attachment of the third sill bracket to the building structure. At the center of the channel web is a longitudinal score mark to center the point of the screws in the channel. Adjacent to the lower flange of the channel and at right angles thereto is a base member vertical wall containing a stucco ground ridge. At the lower edge of the base member vertical wall and at right angles thereto is horizontal base member bottom, which terminates on its inward edge with an upwardly directed lip.

FIG. 15 an exploded perspective view of an alternative embodiment of a sill bracket with a horizontal groove having striated horizontal side walls to receive and retain the threads of machine screws that have a diameter equal to the width of the groove. Beneath the groove and at right angles to it is a vertical wall, under which is a channel and base member identical to that described for FIG. 14. A sample machine screw is shown in proximity to the groove into which it is threaded.

FIG. 16 is an exploded perspective view of an alternative embodiment sill bracket with a recessed bolt head track. Disposed inwardly from the track is a vertical upwardly projecting arm to interface with the building structure. A sample bolt such as used in the track and axially aligned wingnut are shown in proximity to the track.

FIG. 17 is a perspective view of an alternative embodiment header bracket with a downwardly facing channel providing a location for the placement of the top ends of hurricane protection panels and with inwardly projecting ledges to act as a spacer providing separation from a window.

FIG. 18 is a perspective view of an alternative embodiment header bracket with a downwardly facing channel providing a location for the placement of the top ends of hurricane protection panels and with inwardly projecting and with an interior downwardly facing vertical window element receiving slot for the insertion of a window element such as already exists with conventional windows.

FIG. 19 is a perspective view of an alternative embodiment header bracket with a downwardly facing channel providing a location for the placement of the top ends of hurricane protection panels. The bracket includes a spacer to form a space between the window and where the corrugated panels are inserted into the downwardly facing channel. On the inside of the spacer is a window element groove for the insertion of a window element such as already exists with conventional windows.

FIG. 20 is an exploded perspective view of an alternative embodiment sill bracket with a recessed bolt head track. Disposed above and inwardly from the track is a horizontal inwardly projecting arm with vertically projecting grips for the attachment of various architectural features, and which also serves as a spacer to form a space between the window and where the corrugated panels are attached to the sill bracket. Below the face of the recessed bolt head track is a base member vertical wall containing a stucco ground ridge. At the lower edge of the base member vertical wall and at right angles thereto is horizontal base member bottom, which terminates on its inward edge with an upwardly directed lip. A sample bolt such as used in the track and axially aligned wingnut are shown in proximity to the track.

FIG. 21 is an exploded perspective view of an alternative embodiment sill bracket with a recessed bolt head track. Disposed above and inwardly from the track is a horizontal inwardly projecting arm which serves as a spacer to form a space between the window and where the corrugated panels are attached to the sill bracket. At the inside edge of the inwardly projecting arm is a vertical window element receiving slot for the insertion of a window element such as already exists with conventional windows. Beneath the face of the recessed bolt head track and co-planar therewith depends downwardly a vertical member. At the lower edge of the vertical member is an outwardly facing channel in which can be disposed the heads of screws for attachment of the present sill bracket to the building structure. At the center of the channel web is a longitudinal score mark to center the point of the screws in the channel. Adjacent to the lower flange of the channel and at right angles thereto is a base member vertical wall containing a stucco ground ridge. At the lower edge of the base member vertical wall and at right angles thereto is horizontal base member bottom, which terminates on its inward edge with an upwardly directed lip. A sample bolt such as used in the track and axially aligned wingnut are shown in proximity to the track.

FIG. 22 is an exploded perspective view of an alternative embodiment sill bracket with a recessed bolt head track. Disposed directly behind and inwardly from the track body is a vertical window element receiving slot for the insertion of a window element such as already exists with conventional windows. Beneath the face of the recessed bolt head track and co-planar therewith depends downwardly an abbreviated vertical member. At the lower edge of the vertical member is an outwardly facing channel in which can be disposed the heads of screws for attachment of the present sill bracket to the building structure. At the center of the channel web is a longitudinal score mark to center the point of the screws in the channel. Adjacent to the lower flange of the channel and at right angles thereto is a base member vertical wall containing a stucco ground ridge. At the lower edge of the base member vertical wall and at right angles thereto is horizontal base member bottom, which terminates on its inward edge with an upwardly directed lip. A sample bolt such as used in the track and axially aligned wingnut are shown in proximity to the track.

FIG. 23 is a perspective view of an alternative embodiment of a vertical window element receiving slot for the insertion of a window element such as already exists with conventional windows, but with striations on the vertical interior walls of the slot to receive and retain threads.

FIG. 24 is a perspective view of an alternative embodiment of a vertical window element receiving slot for the insertion of a window element such as already exists with conventional windows, but with an interior offset for providing better gripping.

FIG. 25 is a perspective view of an alternative embodiment of a vertical window element receiving slot for the insertion of a window element such as already exists with conventional windows, but with an interior channel for providing better gripping.

FIG. 26 an exploded cross-section view of a masonry window opening using a header bracket from FIG. 18 with a downwardly facing channel providing a location for the placement of the top ends of hurricane protection panels and using a lower sill bracket from FIG. 21 for receiving the head of a threaded bolt for the attachment of bottom ends of the hurricane protection panels with wingnut bolts. The panels are shown to the right of the building aperture with phantom lines illustrating the order of assembly.

FIG. 27 is a broken exploded cross section view of the lower end of a masonry building aperture using a sill bracket, bolt and wingnut for securing a hurricane protection panels (not shown). Seen is an interior projecting arm providing a spacer dividing the surface of the window from the location where the hurricane protection panels are attached to the bolts and wingnuts shown in exploded proximity to the recessed track.

FIG. 28 is a broken exploded cross section view of the lower end of a masonry building aperture using a sill bracket, bolt and wingnut from FIG. 21 for securing a hurricane protection panels (not shown). Included is the horizontal inwardly projecting arm which serves as a spacer to form a space between the window and where the corrugated panels are attached to the sill bracket. At the inside edge of the inwardly projecting arm is a vertical window element receiving slot in which has been inserted the window element. Bolts and wingnuts are shown in exploded proximity to the recessed track.

FIG. 29 is an exploded perspective view of a window using threaded studs penetrating the upper and lower portions of the fin or flange portion of the window providing a means for attaching a hurricane protection panels using a wingnut. Hurricane protection panels are shown in a vertical position, but it is understood that they may also be installed horizontally.

FIG. 30 is an exploded broken cross section view of a masonry building aperture header portion supporting the upper portion of a window with extending threaded studs for the mounting of the upper portion of hurricane protection panels attached by wingnuts as illustrated in exploded axially oriented configuration.

FIG. 31 is an exploded broken cross section view of a masonry building aperture header portion supporting the upper portion of a window, the building shown in phantom, with an angle iron having extending threaded studs through the angle iron and through the fin or flange of a window's edge for the mounting of the tops of hurricane protection panels attached by wingnuts.

FIG. 32 is an exploded broken cross section view of a masonry building aperture header portion supporting the upper portion of a window, the building shown in phantom, with an inverted U-shaped channel with an extending threaded stud through the U-shaped channel and through the fin or flange of a window edge for the mounting of the tops of hurricane protection panels attached by wingnuts.

FIG. 33 is a perspective view of a building having four windows, one hinged door and one sliding glass door. Four windows are shown installed with brackets and hurricane protection panels on the exterior of the windows. One sliding glass door is shown installed with vertical brackets and horizontal hurricane protection panels on the exterior of the sliding glass door. One hinged door is shown with upper and lower rows of threaded studs that offer a means for attaching the upper and lower portion of hurricane protection panels to a hinged door. This allows ingress and egress from the fully protected structure.

FIG. 34 is an exploded perspective view of the hinged door of FIG. 33 with the upper and lower rows of threaded studs that offer the means for attaching the upper and lower portion of hurricane protection panels to a hinged door to allow ingress and egress from the structure. The hurricane protective panels are shown to the right of the door.

FIG. 35 is an exploded perspective view of an alternative embodiment of the door of FIGS. 33 and 34 with upper and lower slide bolt recessed tracks (either flush or recessed) for holding the heads of bolts are used to attach upper and lower portions of hurricane protection panels to the door. Again, the hurricane protection panels are shown to the right of the door.

FIG. 36 is an exploded perspective view of a cross-section of the lower portion of a door with a slide bolt track channel for holding the head a bolt which provides a means for attaching the lower portion of hurricane protection panels to a door. When inverted, the same structure operated to attach the top portions of the panels to the top of the door.

FIG. 37 is an exploded cross-section view of a particle wood door in proximity to a pair of top/bottom J-brackets that add recessed bolt head track bodies containing recessed bolt head tracks to the top and bottom of a door to provide for mounting hurricane protection panels on the outside of the door without restricting egress or ingress through the door.

FIG. 38 is an assembly drawing showing the elements of FIG. 37 completely assembled in the aperture of a masonry building.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

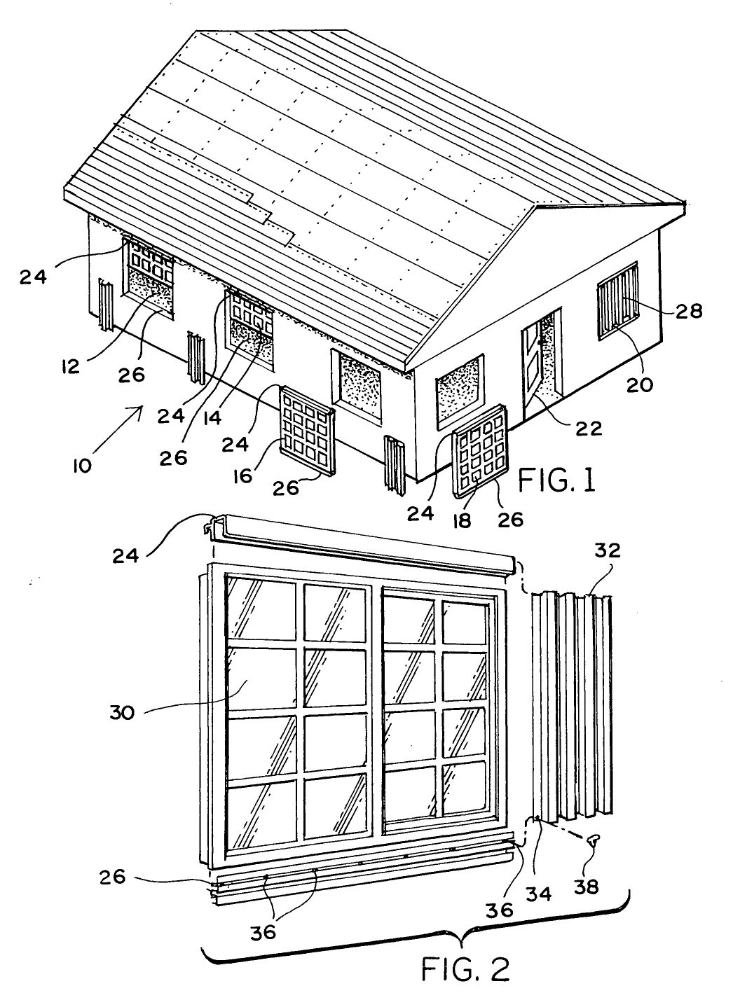

FIG. 1 is a perspective view of a building 10 under construction having six building apertures, five windows 12, 14, 16, 18, and 20, and one hinged door 22. Two windows 16 and 18 are ready for installation with the header 24 and sill 26 brackets in place on the windows. Two windows 12 and 14 are shown installed with the header 24 and sill 26 brackets in place. One window is shown installed with hurricane shutter panels 28 in place to protect the building aperture.

FIG. 2 is an exploded perspective view of header 24 and sill 26 brackets above and below a typical window 30 with partial paneling 32 to the right side of the window. As shown by the phantom lines, the tops of panels 32 are first inserted into the header bracket 24, then the panel bottoms, which are perforated 34 to receive threaded portions of bolts 36 are bolted to sill bracket 26 with wingnuts 38.

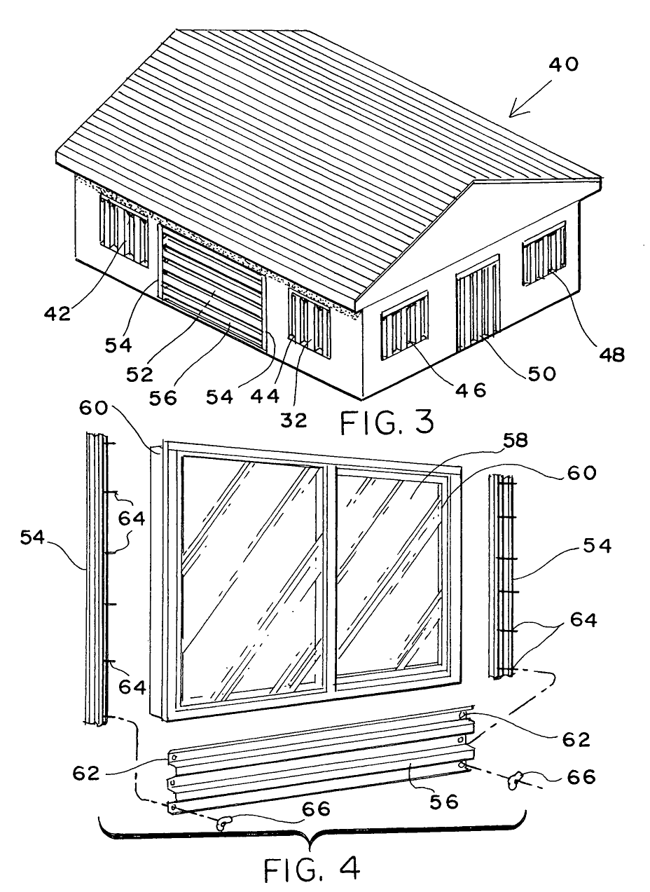

FIG. 3 is a perspective view of a building 40 having six building apertures, four windows 42, 44, 46, and 48, one hinged door 50 and one sliding glass door 52, all of which are covered with the inventive hurricane shutter apparatus. All the building apertures are protected by the preferred embodiment of a header 24 and a sill 26 bracket equipped with vertically disposed isosceles trapezoidal corrugated panels. The sliding glass door 52 is protected with alternative embodiment vertical brackets 54 with horizontal hurricane protection storm panels 56. The vertical brackets 54 are similar to two sill brackets which have bolts to hold the horizontal panels 56 in place as better seen in FIG. 4. The hinged door 50 uses an alternative embodiment exterior wall mounted header 24 and sill 26 supporting the isosceles trapezoidal corrugated panels 32.

FIG. 4 is an exploded perspective view of a typical sliding glass door 58 with vertical brackets to be attached to the sliding glass door jambs 60, with partial paneling 56 beneath the sliding glass door 58. As shown by the phantom lines, the sides of panels 56 which are perforated 62 to receive threaded portions of bolts 64 are bolted to vertical brackets 54 with wingnuts 66.

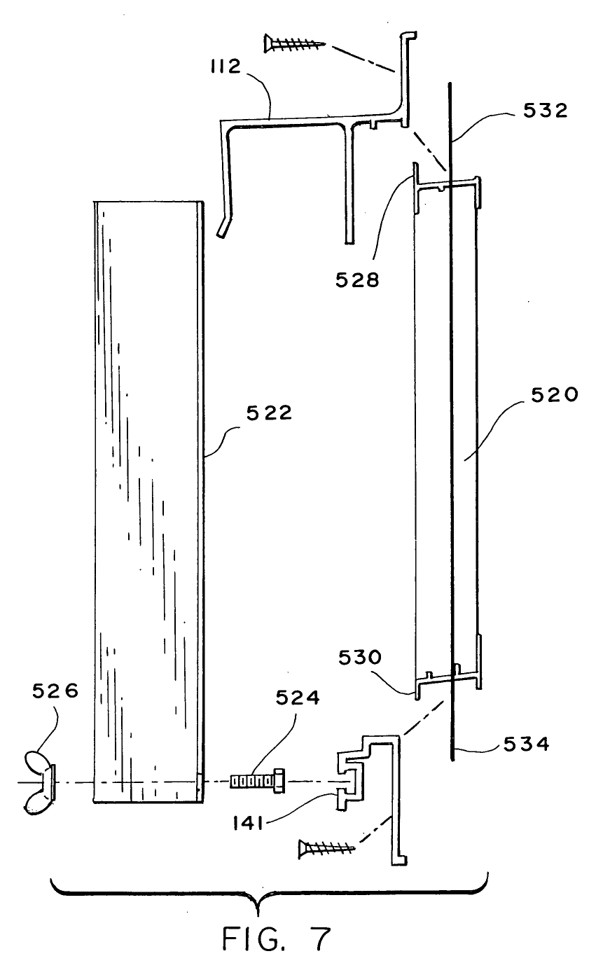

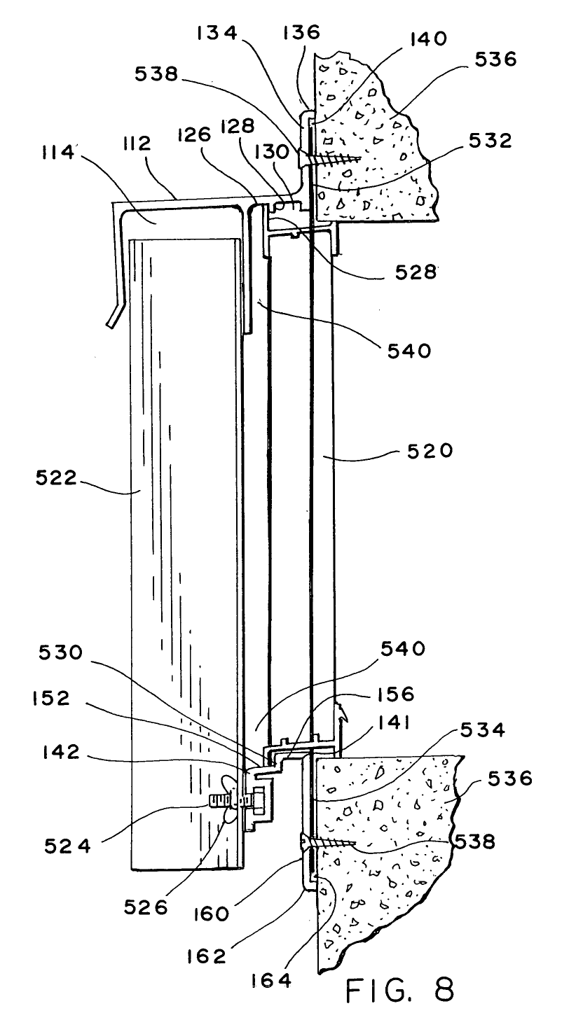

FIG. 5 is a perspective view of a first header bracket 112 comprised of a downwardly facing channel 114 having a channel web 116, inner channel flange 118 and outer channel flange 120. The lower edge of the outer channel flange includes a flare 122. The channel web 116 is co-planar with a horizontal inwardly projecting arm 124. Co-planar with the inwardly projecting arm 124 inside of the inner channel flange 118 is disposed a window element web 126. That terminates with a downwardly depending window element flange 128. The window element flange outer surface 129 is a contact point for a first window element known as a window flange as will be seen in FIG. 8. The window element web 126 doubles as a spacer between the window and where the corrugated panels are inserted into the downwardly facing channel 114. On the inside of the window element flange 128 and co-planar with the horizontal inwardly projecting arm 124 is a window depth spanner 130. The window depth spanner 130 forms a space between the first window element and a second window element described below. At the inside edge of the window depth spanner 130 and disposed at right angles thereto is a vertical arm 134. Finally, the vertical arm 134 is at right angles to a window element ridge 136 inside the top edge 138 of the vertical arm 134. This provides for a window element recess 140 for insertion of the second window element, a window fin such as already exists with conventional fin windows as will be seen in FIGS. 7 and 8.

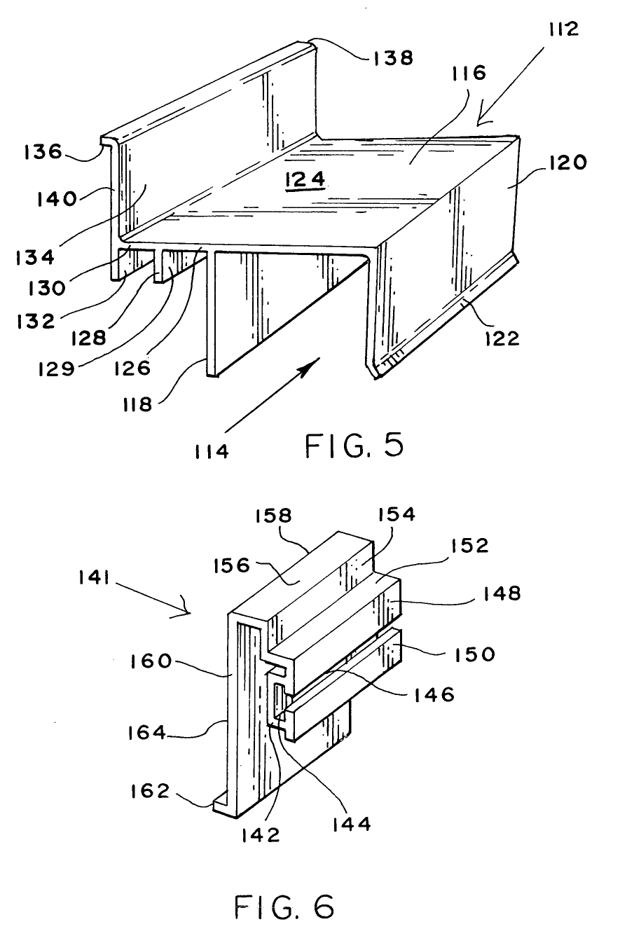

FIG. 6 is a perspective view of a first sill bracket 141 comprised of a recessed bolt head track body 142 containing a recessed bolt head track 144 with a vertical track aperture 146, vertical track upper face 148, and vertical track lower face 150. At right angles to the top of the track upper face 148 is a horizontal track body top 152. It serves as a resting point for a first window element, the window flange, as will be seen in FIG. 8. The horizontal track body top 152 also doubles as a spacer between the window and where the corrugated panels are bolted to the recessed bolt head track body 142. At the inside edge of the track body top 152 and at right angles thereto is a vertical window depth spanner wall 154. At the top edge of the vertical window depth spanner wall 154 and at right angles thereto is a horizontal window depth spanner 156. At the inside edge 158 of the window depth spanner 156 is a vertical downwardly projecting arm 160. At the bottom of the downwardly projecting arm 160 is an inwardly oriented window element ridge 162, which creates a window element recess 164 between the downwardly projecting arm 160 and the building structure for the insertion of a second window element, a window fin, such as already exists with conventional fin windows.

FIG. 7 is an exploded view of the header bracket 112 of FIG. 5 and sill bracket 141 of FIG. 6 with a conventional fin window 520 and with a hurricane shutter panel 522 in proximity to its installation position and with a typical bolt 524 and wingnut 526 used to secure the panel upon installation to the sill bracket 141. Fin window 520 includes a first window feature, window flanges 528 and 530, and second window feature, window fins 532 and 534.

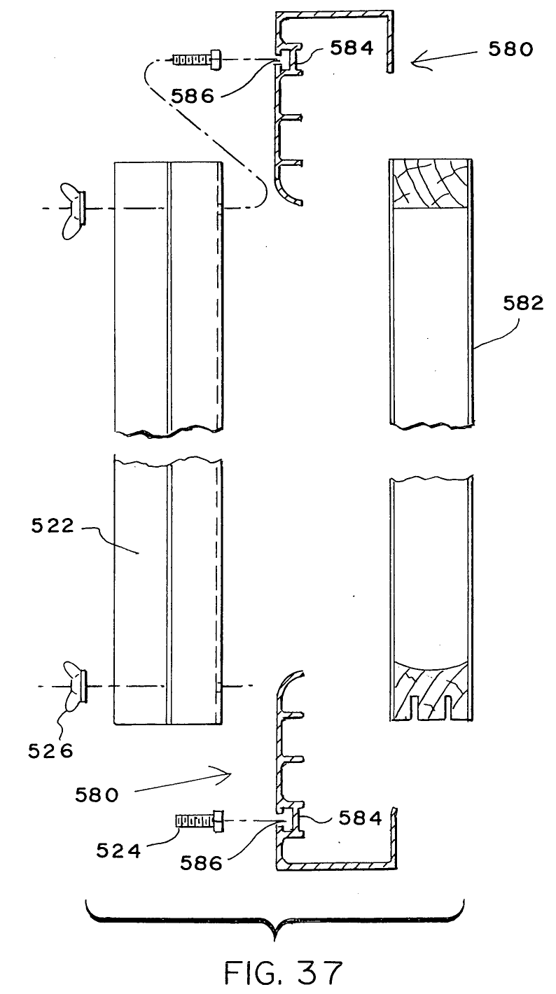

FIG. 8 is an assembly drawing showing the elements of FIG. 37 completely assembled on a wood frame building 536. Header bracket 112 is shown assembled with fin window 520 to wood frame building 536 using wood screw 538. Wood screw 538 passes through vertical arm 134 of header bracket 112 first, then through window fin 532 before reaching the wood of building 536. Note that window element ridge 136 creates a window element recess 140 for window fin 532. Also note that window element flange 128 provides a contact point for window flange 528. Further note that window element web 126 provides a spacer 540 between window 520 and where corrugated panels 522 are inserted into downwardly facing channel 114. Finally note that window depth spanner 130 forms a space between first window element, window flange 528, and second window element, window fin 532. All of these spacing considerations make header bracket 112 completely compatible with conventional fin window 520 and show that the bracket 112 can be readily assembled with conventional fin window 520 when the latter is first placed in a wood frame building aperture at the time of construction.

The same is true for sill bracket 141. Wood screw 538 passes first through vertical downwardly projecting arm 160 of sill bracket 141 and then through window fin 534 before reaching wood frame building 536. Also window element ridge 162 creates window element recess 164 to accommodate window fin 534. Also note that window flange 530 rests on horizontal track body top 152 and that horizontal track body top 152 also doubles as a spacer 540 between the window 520 and the corrugated panels 522 bolted to the recessed bolt head track body 142. Note that horizontal window depth spanner 156 establishes the proper distance between window flange 530 and window fin 534. So the sill bracket 141 meshes perfectly with conventional fin window 520. Hurricane shutter panels 522 are firmly attached to sill bracket 114 using bolts 524 and wingnuts 526.

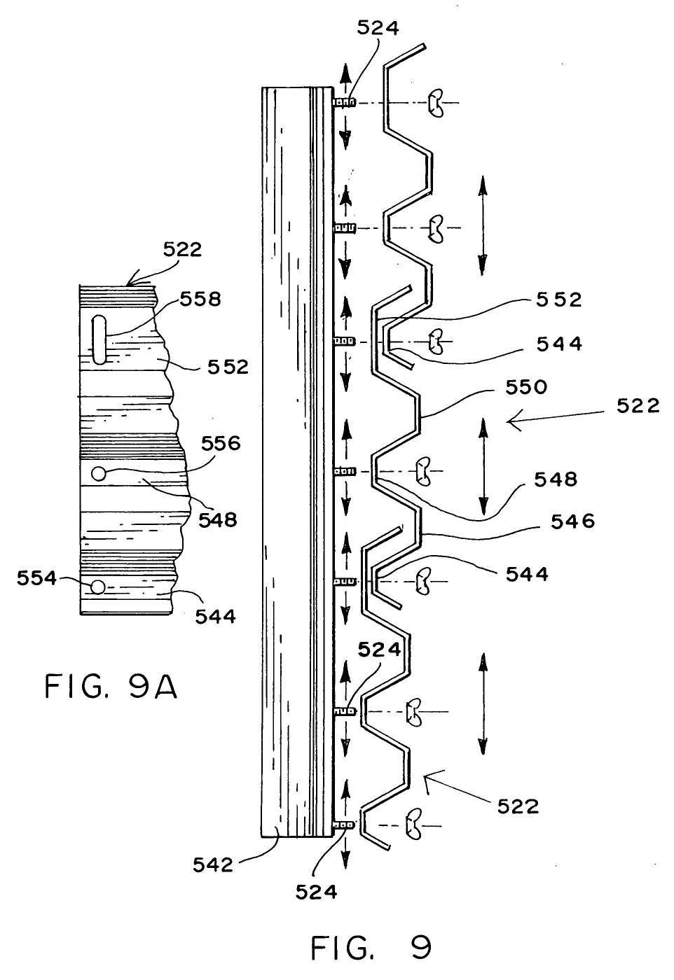

FIG. 9 is an exploded bottom view of a sill bracket 542 and hurricane protection storm panels 522 in proximity thereto. A plurality of bolts 524 are slidingly installed in a track of bottom sill 542 as seen in FIG. 8. The fact that they can slide laterally is illustrated by up and down arrows intercepting the threaded portion of each bolt 524. Hurricane panels 522, described early in this application as adjustable, lightweight isosceles trapezoidal corrugated panels, are attached to bolts 524 using wingnuts 522 shown in exploded proximal alignment to each other. Each panel 522 includes several conventionally sized isosceles trapezoidal corrugations 544, 546, 548, and 550 followed by a wider than usual isosceles trapezoidal corrugation 552. Overlapping the wide corrugation 552 is a conventionally sized corrugation 544′. As FIG. 9 shows, this means that panels can be adjusted laterally with respect to each other because the conventionally sized corrugation 544 can be slid one way or the other within the wide corrugation 552.

FIG. 9A is a broken back elevation view of the bottom edge of a single hurricane protection storm panel 522. Each of the alternating corrugations that come in contact with sill bracket 542, such as corrugations 544 and 548, include perforations 554 and 556 to accommodate the threaded portions of bolts 524. But for wide corrugation 552 there is instead provided a slot 558 to accommodate the adjustment function with regard to the adjoining panel having a first corrugation 544′. This adjustment feature is obviously to accommodate different building aperture widths.

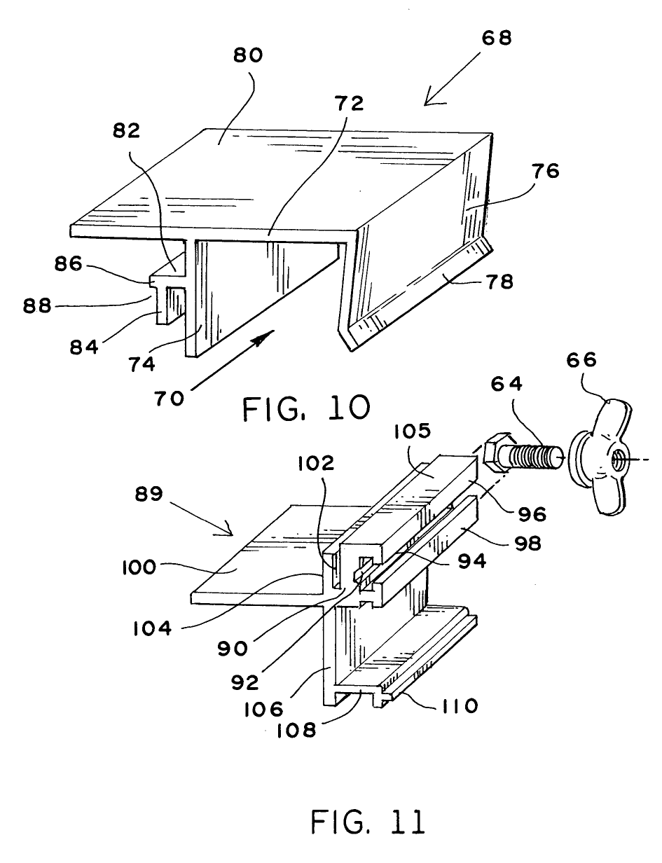

FIG. 10 is a perspective view of a second header bracket 68 comprised of a downwardly facing channel 70 having a channel web 72, inner channel flange 74 and outer channel flange 76. The lower edge of the outer channel flange includes a flare 78. The channel web 72 is co-planar with a horizontal inwardly projecting arm 80 to interface with the building structure. On the inside of the inner channel flange 74 and part way down the inner channel flange 74 is a horizontal spacer web 82. At the inside of the spacer web is a downwardly depending window element wall 84. Inner channel flange 74, spacer web 82 and downwardly depending window element wall 84 together form a space between the window and where the corrugated panels are inserted into the downwardly facing channel 70. Co-planar with the spacer web 82 and inside of the window element wall 84 is a window element ridge 86. The window element ridge creates a window element recess 88 between the building and the window element wall 84 for the insertion of a window element, a window flange, such as already exists with conventional flange windows.

FIG. 11 is an exploded perspective view of a second sill bracket 89 comprised of a recessed bolt head track body 90 containing a recessed bolt head track 92 with a track aperture 94, track upper face 96, and track lower face 98. Co-planar with the track lower face 98 is a horizontal inwardly projecting arm 100 to interface with the building structure. Disposed inwardly from the bolt head track 92 is a vertical window element receiving slot 102 for the insertion of a window element, a window flange, such as already exists with conventional flange windows. The slot 102 is formed between the recessed bolt head track body 90 and a parallel vertical slot wall 104. Recessed bolt head track body top 105 is of a width sufficient to provide a spacer between the window and where the corrugated panels are bolted to the recessed bolt head track body 90. Co-planar with the slot wall 104 and depending vertically downwardly from beneath the horizontal plane of the inwardly projecting arm 100 is the downwardly projecting arm 106. At the lower end of downwardly projecting arm 106 is base member 108, on which is disposed stucco ground ridge 110.

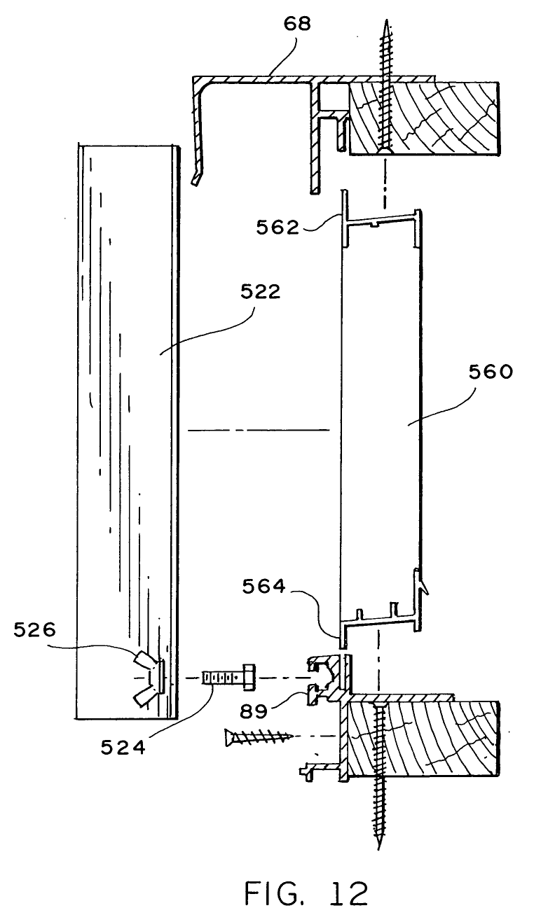

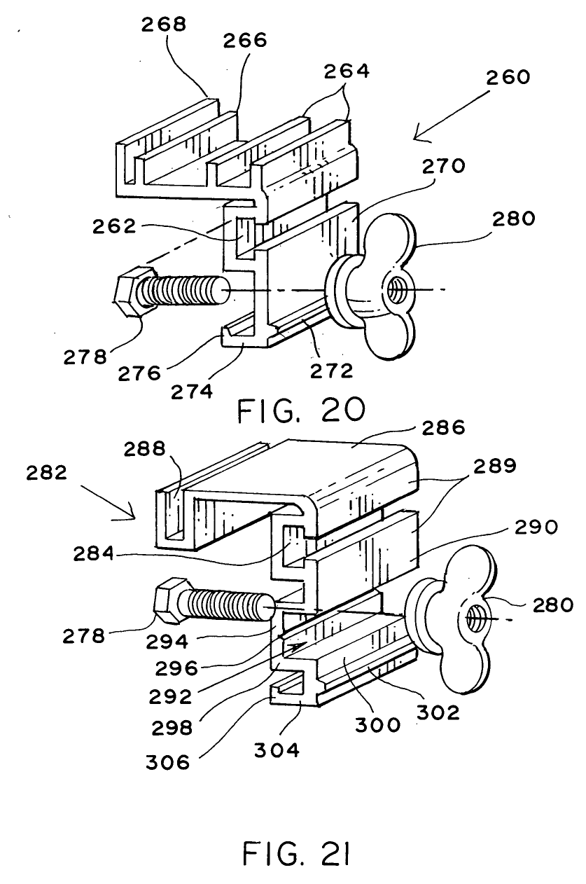

FIG. 12 is an exploded view of the header bracket 68 of FIG. 20 and the sill bracket 89 of FIG. 21 with a conventional flange window 560 and with a hurricane shutter panel 522 in proximity to its installation position and with a typical bolt 524 and wingnut 526 used to secure the panel upon installation to the sill bracket 89. Flange window 560 includes window features, termed window flanges 562 and 564.

FIG. 13 is an assembly drawing showing the elements of FIG. 40 completely assembled in a masonry building 566. Conventional flange window 560 is shown installed in the masonry building 566 aperture between portions of wood buck 568 and 570. The opening seen between masonry 566 and wood buck 570 is for shimming and caulking (not shown). The header bracket 68 is shown attached to masonry 566 through its horizontal inwardly projecting arm 80 using threaded masonry anchor 572 which passes first through wood buck 568 and then horizontal inwardly projecting arm 80. Sill bracket 89 is shown attached to masonry building 566 indirectly. First, threaded masonry anchor 574 secures wood buck 570 to masonry building 566. Second, sill bracket 89 is attached to wood buck 570 using wood screw 578 which passes through downwardly projecting arm 106 of sill bracket 89. Flange window 560 is held in position at its top by the retention of window flange 562 by a window element recess 88 formed by window element ridge 86. Conventional flange window 560 is held in position at its bottom by window flange 564 being retained in vertical window element receiving slot 102 in sill bracket 89. Spacer web 82 in header bracket 68 provides a space 576 between flange window 560 and where corrugated panels 522 are placed in downwardly facing channel 70 in header bracket 68. Similarly, recessed bolt head track body top 105 provides a space 576 between flange window 560 and where corrugated panels 522 are bolted to recessed bolt head track body 90.

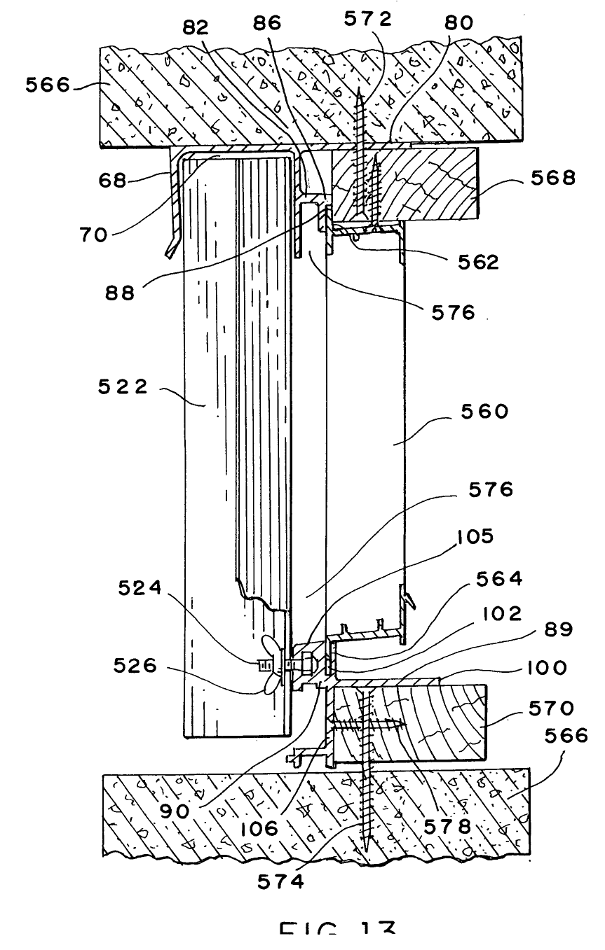

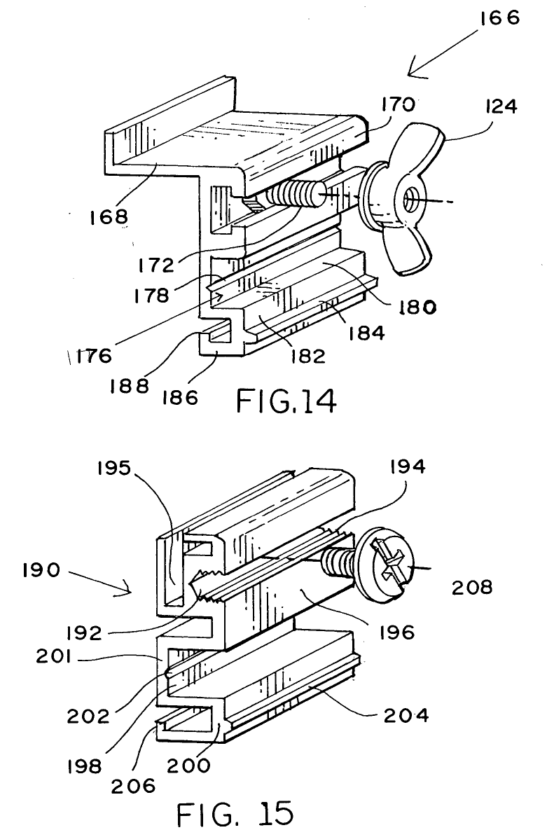

FIG. 14 is an exploded perspective view of an alternative embodiment sill bracket 166 for use with a sliding or roller window, but it lacks the recessed bolt head track of the first and second sill brackets. It includes a horizontal flat track 168 at its top to interface with the frame of the window, from the outside edge of which depends downwardly a vertical member 170. The vertical member 170 is perforated by one of a plurality of bolts 172 pointing horizontally outward threaded through the vertical member 170. These receive wingnuts 174, one of which is shown in axial proximity to the bolt 172. The nuts 174 and bolts 172 attach isosceles trapezoidal panels to the third sill bracket 166. At the lower edge of the vertical member 170 is an outwardly facing channel 176 in which can be disposed the heads of screws for attachment of the third sill bracket 166 to the building structure. At the center of the channel web is a longitudinal score mark 178 to center the point of the screws in the channel 176. Adjacent to the lower flange 180 of the channel 176 and at right angles thereto is a base member vertical wall 182 containing a stucco ground ridge 184. At the lower edge of the base member vertical wall 182 and at right angles thereto is horizontal base member bottom 186, which terminates on its inward edge with an upwardly directed lip 188.

FIG. 15 is an exploded perspective view of an alternative embodiment of a sill bracket 190 with a horizontal groove 192 having striated horizontal side walls 194 to receive and retain the threads of machine screws that have a diameter equal to the width of the groove 192. Inward and behind groove 192 is vertical window element receiving slot 195 for the insertion of a window element such as already exists with conventional windows. Beneath the groove 192 and at right angles to it is an abbreviated vertical wall 196, under which is a horizontal channel 198 and base member 200 identical to that described for FIG. 14. At the center of the channel web 201 of the channel 198 is longitudinal score mark 202, which is used to center the point of screw (not shown) that attaches the sill bracket to the building structure. The base member 200 includes a stucco ground ridge 204 and lip 206. A sample machine screw 208 is shown in proximity to the groove 192 into which it is threaded.

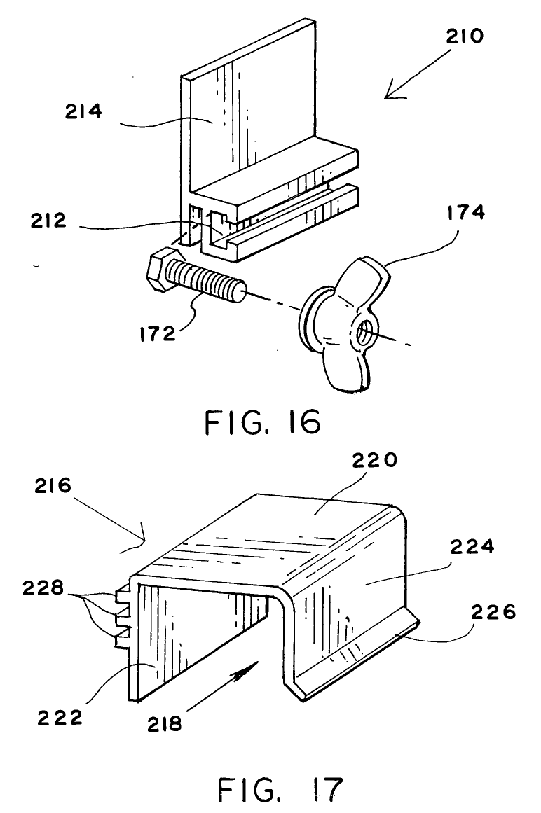

FIG. 16 is an exploded perspective view of an alternative embodiment sill bracket 210 with a recessed bolt head track 212. Disposed inwardly from the track is a vertical upwardly projecting arm 214 to interface with the building structure. A sample bolt 172 such as used in the track 212 and axially aligned wingnut 174 are shown in proximity to the track.

FIG. 17 is a perspective view of an alternative embodiment header bracket 216 with a downwardly facing channel 218 providing a location for the placement of the top ends of hurricane protection panels. The channel is comprised of a channel web 220, inner channel flange 222, and outer channel flange 224. The outer channel flange includes a flare 226. On the inner channel flange 222 is inwardly projecting ledges 228 to act as a spacer providing separation from a window.

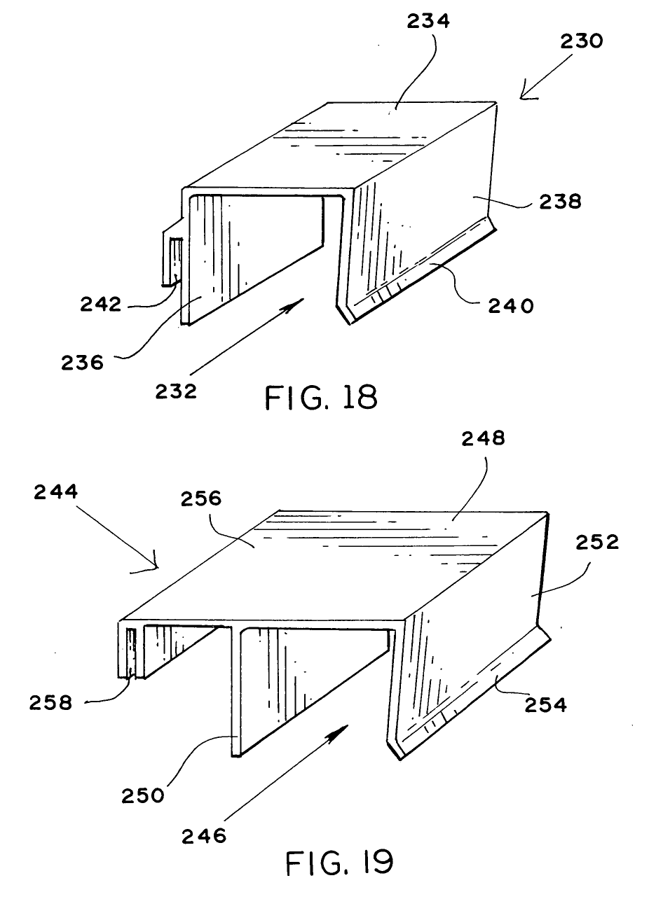

FIG. 18 is a perspective view of an alternative embodiment header bracket 230 with a downwardly facing channel 232 providing a location for the placement of the top ends of hurricane protection panels. The channel 232 is comprised of a channel web 234, inner channel flange 236, and outer channel flange 238. The outer channel flange includes a flare 240. On the inner channel flange 236 is an interior downwardly facing vertical window element receiving slot 242 for the insertion of a window element such as already exists with conventional windows.

FIG. 19 is a perspective view of an alternative embodiment header bracket 244 with a downwardly facing channel 246 providing a location for the placement of the top ends of hurricane protection panels. The channel 246 is comprised of a channel web 248, inner channel flange 250, and outer channel flange 252. The outer channel flange includes a flare 254. Co-planar with the channel web 248 is an inwardly projecting arm 256 which acts as an inward spacer to form a space between the window and where the corrugated panels are inserted into the downwardly facing channel 246. On the inside edge of the inwardly projecting arm 256 is a downwardly facing window element groove 258 for the insertion of a window element such as already exists with conventional windows.

FIG. 20 is an exploded perspective view of an alternative embodiment sill bracket 260 with a recessed bolt head track 262. Disposed above and inwardly from the track is a horizontal inwardly projecting arm 264 with vertically projecting grips 266, 268 for the attachment of various architectural features, and which also serves as a spacer to form a space between the window and where the corrugated panels are attached to the sill bracket 260. Below the face of the recessed bolt head track 262 is a base member vertical wall 270 containing a stucco ground ridge 272. At the lower edge of the base member vertical wall 270 and at right angles thereto is horizontal base member bottom 274, which terminates on its inward edge with an upwardly directed lip 276. A sample bolt 278 such as used in the track 262 and axially aligned wingnut 280 are shown in proximity to the track 262.

FIG. 21 is an exploded perspective view of an alternative embodiment sill bracket 282 with a recessed bolt head track 284. Disposed above and inwardly from the track 284 is a horizontal inwardly projecting arm 286 which serves as a spacer to form a space between the window and where the corrugated panels are attached to the sill bracket 282. At the inside edge of the inwardly projecting arm 286 is a vertical window element receiving slot 288 for the insertion of a window element such as already exists with conventional windows. Beneath the face 289 of the recessed bolt head track 284 and co-planar therewith depends downwardly an abbreviated vertical wall member 290. At the lower edge of the abbreviated vertical wall member 290 is an outwardly facing channel 292 in which can be disposed the heads of screws (not shown) for attachment of the present sill bracket 282 to the building structure. At the center of the channel web 294 is a longitudinal score mark 296 to center the point of the screws (not shown) in the channel 292. Adjacent to the lower flange 298 of the channel 292 and at right angles thereto is a base member vertical wall 300 containing a stucco ground ridge 302. At the lower edge of the base member vertical wall 300 and at right angles thereto is horizontal base member bottom 304, which terminates on its inward edge with an upwardly directed lip 306. A sample bolt 278 such as used in the track 284 and an axially aligned wingnut 280 are shown in proximity to the track 284.

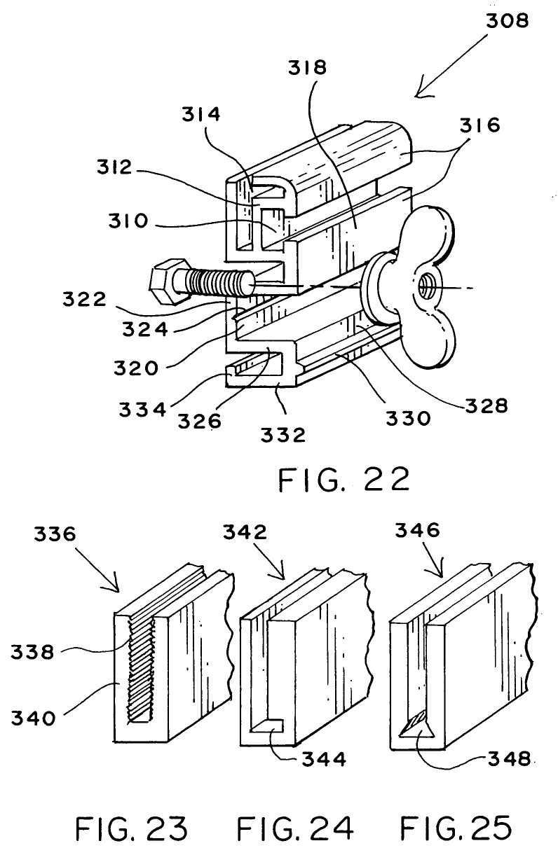

FIG. 22 is an exploded perspective view of an alternative embodiment sill bracket 308 with a recessed bolt head track 310. Disposed directly behind and inwardly from the track body 312 is a vertical window element receiving slot 314 for the insertion of a window element such as already exists with conventional windows. Beneath the face 316 of the recessed bolt head track 310 and co-planar therewith depends downwardly an abbreviated vertical wall member 318. At the lower edge of the abbreviated vertical member 318 is an outwardly facing channel 320 in which can be disposed the heads of screws (not shown) for attachment of the present sill bracket 308 to the building structure. At the center of the channel web 322 is a longitudinal score mark 324 to center the points of the screws (not shown) in the channel 320. Adjacent to the lower flange 326 of the channel 320 and at right angles thereto is a base member vertical wall 328 containing a stucco ground ridge 330. At the lower edge of the base member vertical wall 328 and at right angles thereto is horizontal base member bottom 332, which terminates on its inward edge with an upwardly directed lip 334. A sample bolt 278 such as used in the track 310 and an axially aligned wingnut 280 are shown in proximity to the track 310.

FIG. 23 is a perspective view of an alternative embodiment of a vertical window element receiving slot 336 for the insertion of a window element such as already exists with conventional windows, but with striations 338 on the vertical interior walls 340 of the slot to receive and retain threads.

FIG. 24 is a perspective view of an alternative embodiment of a vertical window element receiving slot 342 for the insertion of a window element such as already exists with conventional windows, but with an interior offset 344 for providing better gripping.

FIG. 25 is a perspective view of an alternative embodiment of a vertical window element receiving slot 346 for the insertion of a window element such as already exists with conventional windows, but with an interior wedge 348 for providing better gripping.

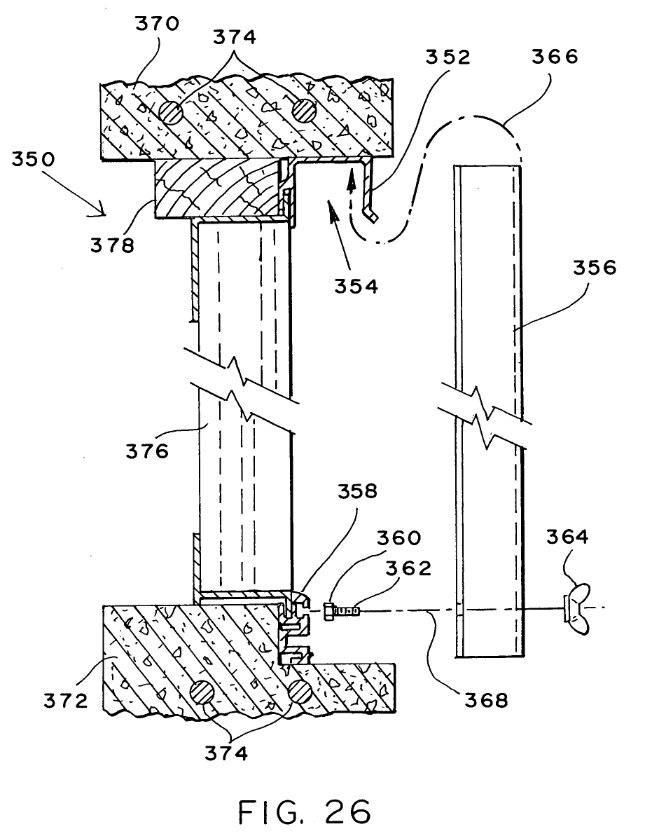

FIG. 26 an exploded broken cross section view of a masonry window opening 350 using a header bracket 352 from FIG. 16 with a downwardly facing channel 354 providing a location for the placement of the top ends of hurricane protection panels 356 and using a lower sill bracket 358 from FIG. 23 for receiving the head 360 of a threaded bolt 362 for the attachment of bottom ends of the hurricane protection panels 356 with wingnuts 364. The panels 356 are shown to the right of the building aperture 350 with phantom lines 366 first and 368 second illustrating the order of assembly. FIG. 26 further shows the masonry building in broken cross section 370 and 372 with rebars 374 reinforcing the masonry. A window 376 is shown in the window opening 350, with the upper portion of the window 376 shown supported by wood buck 378.

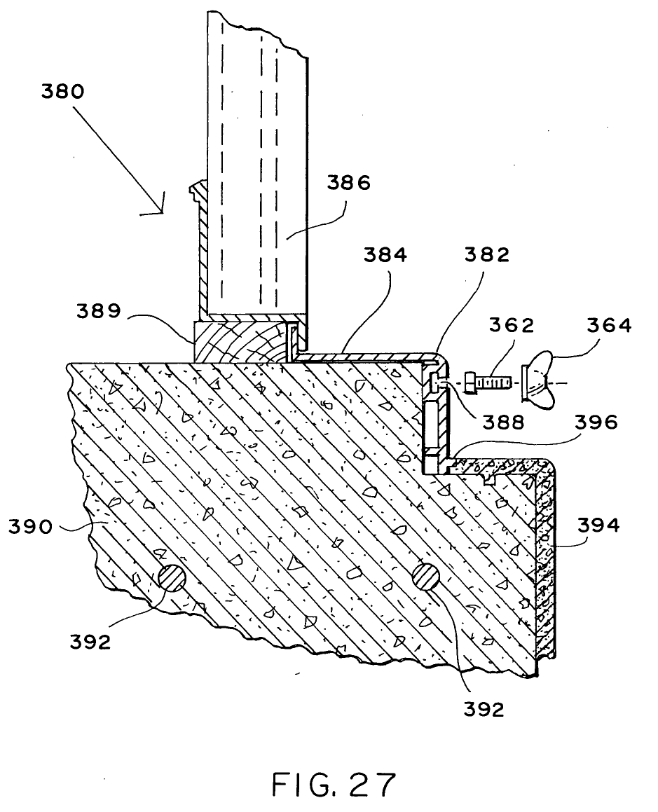

FIG. 27 is a broken exploded cross section view of the lower end of a masonry building aperture 380 using a sill bracket 382, bolt 362 and wingnut 364 for securing hurricane protection panels (not shown). Seen is an inwardly projecting arm 384 providing a spacer dividing the surface of the window 386 from the location where the hurricane protection panels are attached to the bolts 362 and wingnuts 364 shown in exploded proximity to the recessed track 388. Window 386 is shown supported by wood buck 389. Again the masonry 390 is in cross section with rebar 392. The exterior of the masonry 390 is covered by stucco 394, the limit of which in connection with sill bracket 382 is set by stucco ground ridge 396.

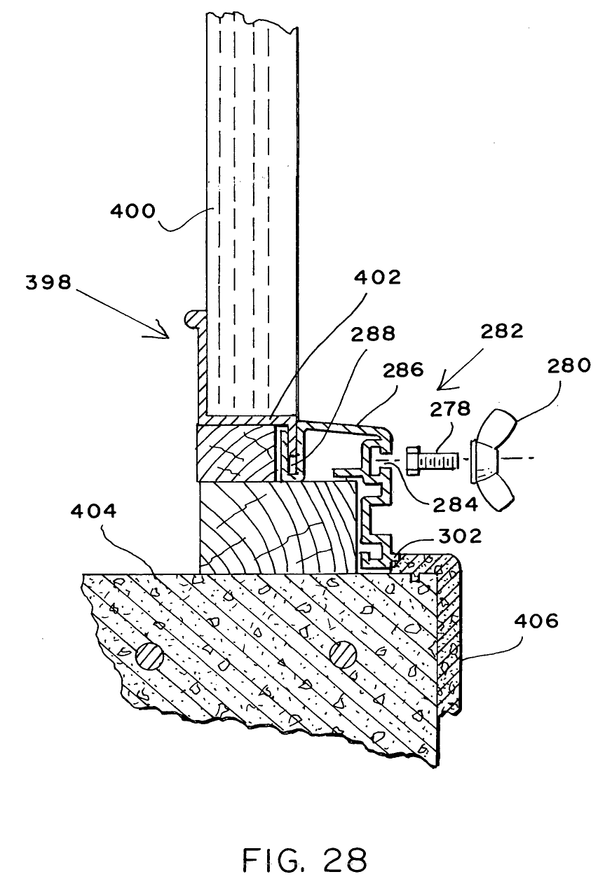

FIG. 28 is a broken exploded cross section view of the lower end of a masonry building aperture 398 using a sill bracket 282, bolt 278 and wingnut 280 from FIG. 23 for securing a hurricane protection panels (not shown). Included is the horizontal inwardly projecting arm 286 which serves as a spacer to form a space between the window 400 and where the corrugated panels (not shown) are attached to the sill bracket 282. At the inside edge of the inwardly projecting arm 286 is a vertical window element receiving slot 288 in which has been inserted the window element 402. Bolts 278 and wingnuts 280 are shown in exploded proximity to the recessed track 284. Masonry 404 is shown faced with stucco 406 the limit of which in regard to the sill bracket 282 is set by stucco ground ridge 302.

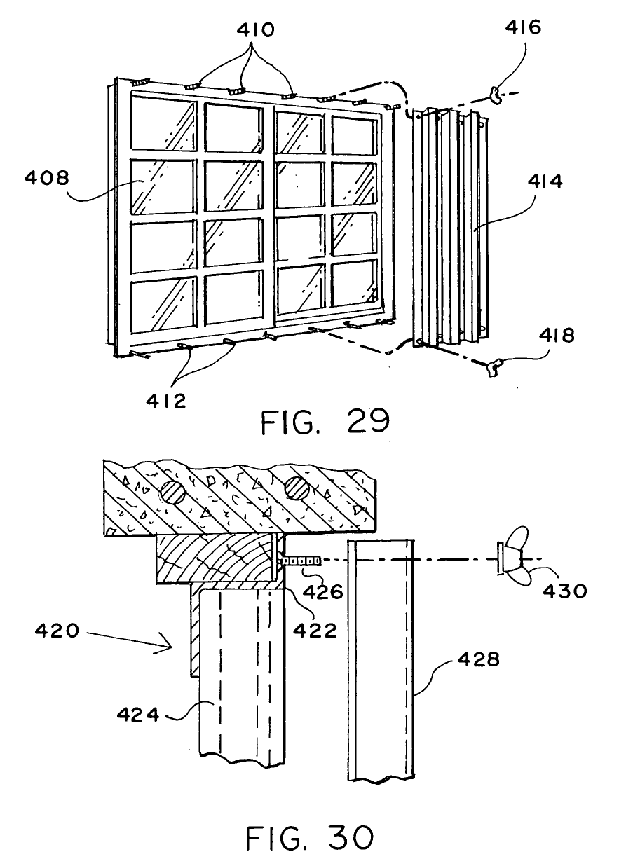

FIG. 29 is an exploded perspective view of a window 408 using threaded studs 410 and 412 penetrating the upper and lower portions of the fin or flange portion of the window providing a means for attaching a hurricane protection panels 414 using wingnut 416 and 418. Hurricane protection panels 414 are shown in a vertical position, but it is understood that they may also be installed horizontally as shown in FIGS. 3 and 4.

FIG. 30 is an exploded broken cross section view of a masonry building aperture 420 header portion 422 supporting the upper portion of a window 424 with extending threaded studs 426 for the mounting of the tops of hurricane protection panels 428 attached by wingnuts 430 as illustrated in exploded axially oriented configuration.

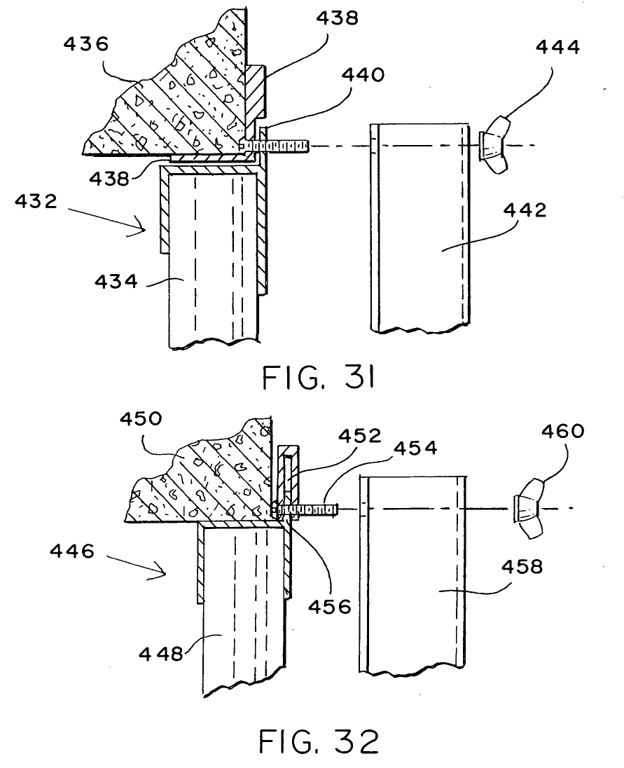

FIG. 31 is an exploded broken cross section view of a masonry building aperture 432 header portion supporting the upper portion of a window 434, the building shown in phantom 436, with an angle iron 438 having extending threaded studs 440 through the angle iron 438 and through the fin or flange 440 of a window 434 edge for the mounting of the tops of hurricane protection panels 442 attached by wingnuts 444.

FIG. 32 is an exploded broken cross section view of a masonry building aperture 446 header portion supporting the upper portion of a window 448, the building shown in phantom 450, with an inverted U-shaped channel 452 with an extending threaded studs 454 through the U-shaped channel 452 and through the fin or flange 456 of a window 448 edge for the mounting of the tops of hurricane protection panels 458 attached by wingnuts 460.

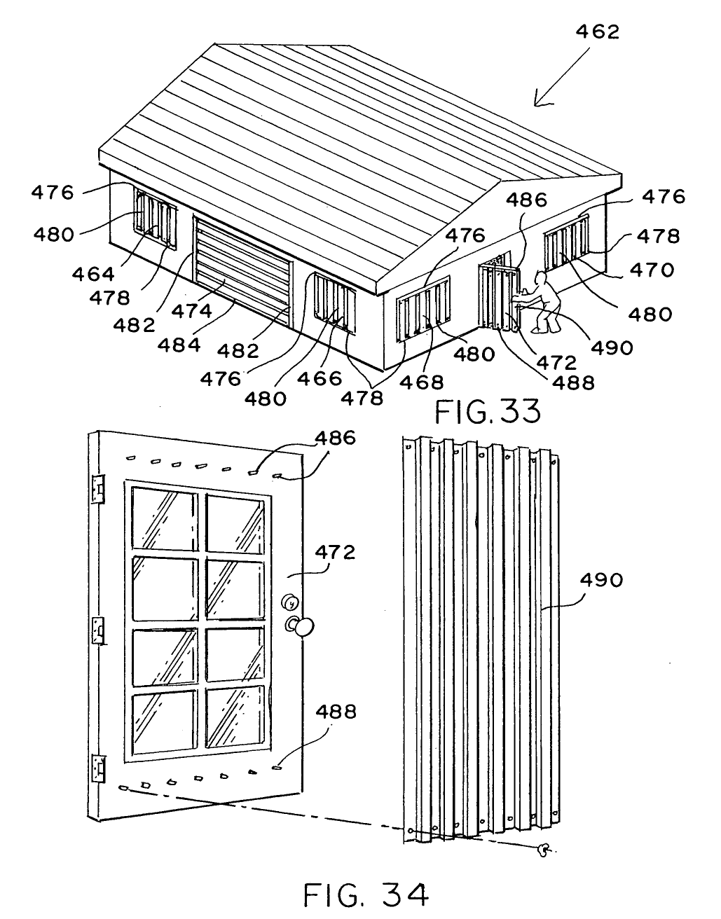

FIG. 33 is a perspective view of a building 462 having four windows 464, 466, 468, and 470, one hinged door 472 and one sliding glass door 474. The four windows are shown installed with brackets 476 and 478 and hurricane protection panels 480 on the exterior of the windows 464, 466, 468, and 470. One sliding glass door 474 is shown installed with vertical brackets 482 and horizontal hurricane protection panels 484 on the exterior of the sliding glass door 474. One hinged door 472 is shown with upper 486 and lower 488 rows of threaded studs that offer a means for attaching the upper and lower portion of hurricane protection panels 490 to a hinged door 472. This allows ingress and egress from the fully protected structure.

FIG. 34 is an enlarged exploded perspective view of the hinged door 472 of FIG. 33 with the upper 486 and lower 488 rows of threaded studs that offer the means for attaching the upper and lower portion of hurricane protection panels 490 to a hinged door 472 to allow ingress and egress from the structure. The hurricane protective panels 490 are shown to the right of the door.

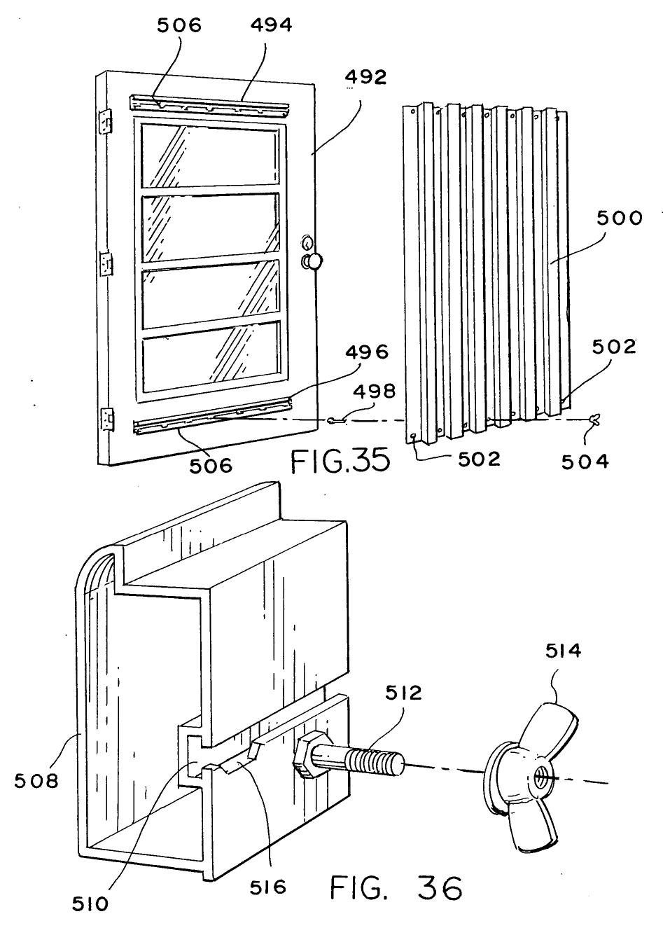

FIG. 35 is an exploded perspective view of an improved embodiment of a hinged door 492 similar to that shown in FIGS. 33 and 34, but with upper 494 and lower 496 slide bolt recessed tracks for holding the heads of bolts 498 that are used to attach upper and lower portions of hurricane protection panels 500 to the door 492. This is done by passing the bolts 498 through perforations 502 in the hurricane protection panels 500 and applying wingnuts 504 to the bolts 498. In FIG. 35, the slide bolt recessed track bodies 506 are applied to the exterior of a conventional door 492.

FIG. 36 is an exploded perspective view of a cross section of the lower portion 508 of a more improved door with a slide bolt track channel 510 that is recessed within the door for holding the head of a bolt 512 that provides the means for attaching the lower portion of hurricane protection panels 500 (as shown in FIG. 35) to a door using a wingnut 514. When inverted, the same structure operated to attach the top portions of the panels 500 to the top of the door. Because the slide bolt track channel 510 is recessed within the door, access by the bolt 512 heads to the track 510 must be had through relief notch 516.

FIG. 37 is an exploded cross section view of a pair of add on recessed bolt head track door J-brackets 580 with a pre-existing particle wood door 582 in proximity to hurricane protection shutter panels 522. The J-brackets 580 add recessed bolt head track bodies 584 containing recessed bolt head tracks 586 to the top and bottom of the door 582 for retaining bolt heads 524, to which are then applied the shutter panels 522 and wingnuts 526.

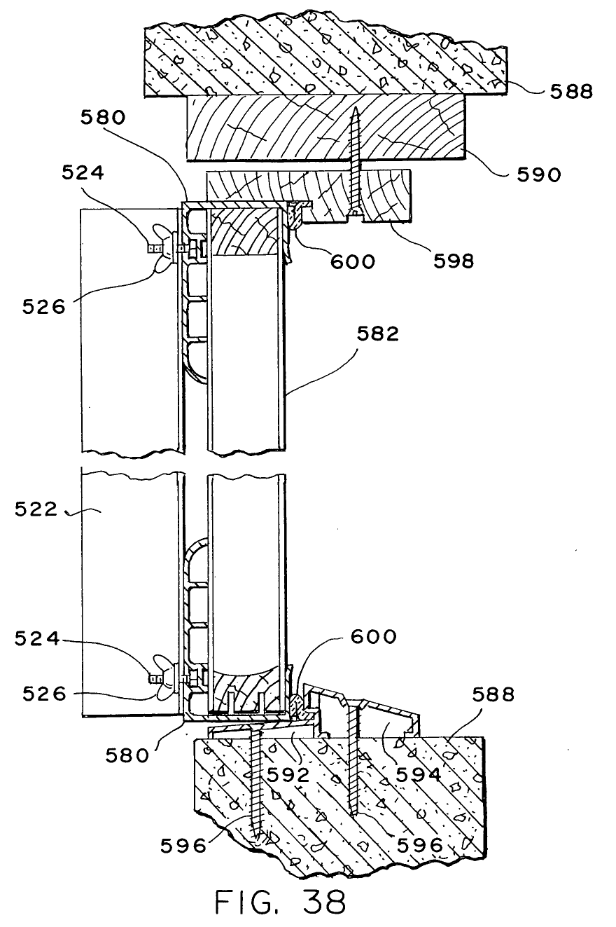

Turning finally to FIG. 38, an assembly drawing showing add on recessed bolt head track door J-brackets 580 applied respectively to the top and bottom of wood particle door 582, to which has been applied hurricane protection shutters 522 using bolts 524 and wingnuts 526. The door 582 with J-brackets 580 and panels 522 is installed in a masonry building 588 with wood buck 590, conventional door sill 592, and interior molding 594 held by threaded masonry anchors 596. The top mates with conventional wood frame header 598. The periphery of the door 582 is surrounded by resilient compressible weather stripping 600. One significant advantage of these add on recessed bolt head track door J-brackets 580 is that they allow the application of hurricane protection shutter panels 522 to a pre-existing door with little or no modification thereto and without interfering with the door's ingress and egress functions when the shutters 522 are deployed for storm protection. Additionally, if the door contains any glazing, the glazing is covered and protected. Finally, the door is strengthened by the application of the J-brackets 580 whether or not the hurricane protection panels 522 are deployed thereon.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A storm shutter apparatus for use with conventional fenestration products that are unmodified for I.B.C. compliance and which are installed at original building construction comprising:
simple cross section header and sill brackets that are combined with the products before installation of the combination into a conventionally sized building aperture; and
isosceles trapezoidal corrugated shutter panels to be selectively attached to the header and sill brackets for storm protection, which together render the building aperture I.B.C. compliant.

2. The apparatus of claim 1 in which each bracket includes means to interface with conventional fenestration products enabling the brackets and products to be combined into a single structure before the installation of the combination into the building aperture.

3. The apparatus of claim 1 in which the header bracket further comprises a downwardly facing channel to selectively receive and retain tops of the panels.

4. The apparatus of claim 1 in which the sill bracket further comprises a recessed bolt head track.

5. The apparatus of claim 1 in which each bracket includes a spacer to separate the fenestration products from the shutter panels to provide working room for selective installation of the shutter panels in the brackets.

6. The apparatus of claim 1 in which the shutter panels are selectively disposed vertically with tops inserted into a downwardly facing channel in the header bracket and bottoms attached to the sill bracket using bolts with heads inserted into a recessed bolt head track in the sill bracket, said bolts passing through perforations in the bottoms of the shutter panels to fix in place the shutter panels using wingnuts threaded onto the bolts.

7. The apparatus of claim 3 in which the downwardly facing channel includes a channel web, inner channel flange, and outer channel flange, the lower edge of the outer channel flange including a flare.

8. The apparatus of claim 1 in which brackets further comprise vertical window element slots and recesses for the insertion and retention of window elements such as already exist with conventional fenestration products.

9. The apparatus of claim 1 in which the brackets further comprise spacer elements to provide for space between the fenestration products and where the shutter panels are selectively installed.

10. The apparatus of claim 1 in which the apparatus further complies with the Florida Building Code 2001 Nonhigh Velocity Hurricane Zones.

11. The apparatus of claim 1 in which the apparatus further achieves Large Missile Impact Resistance in conformance with ASTM-E 1886-97, 1996-99.

12. The apparatus of claim 1 in which the apparatus further complies with the uniform load structural test ASTM E-330.

13. A storm shutter apparatus for use with conventional fenestration products that are unmodified for I.B.C. compliance and which are installed at original building construction comprising:
simple cross section header brackets having downwardly facing channels;
simple cross section sill brackets having recessed bolt head tracks;
the header and sill brackets including vertical window element slots and recesses for the insertion and retention of window elements such as already exist with conventional fenestration products;
isosceles trapezoidal corrugated shutter panels to be selectively disposed vertically with tops inserted into the downwardly facing channels in the header brackets and bottoms attached to the sill brackets using bolts with heads inserted into a recessed bolt head tracks in the sill bracket, said bolts passing through perforations in the bottoms of the shutter panels to fix in place the shutter panels using wingnuts threaded onto the bolts; and
each bracket including a spacer to separate the fenestration products from the shutter panels to provide working room for selective installation of the shutter panels in the brackets.

14. A storm shutter apparatus for use with conventional fenestration products that are unmodified for I.B.C. compliance comprising:
simple cross section sill brackets having recessed bolt head tracks for disposition near an outside periphery of the products such as hinged doors and sliding glass doors installed at building apertures; and
isosceles trapezoidal corrugated shutter panels to be selectively attached to the sill brackets for storm protection using bolts with their heads retained in the recessed bolt head tracks, the bolts penetrating perforations near ends of the panels with the panels held to the sill brackets by tightened wingnuts threaded onto the bolts, all of which together render the building apertures I.B.C. compliant.

15. The apparatus of claim 14 in which the sill brackets are deployed at tops and bottoms of doors making the orientation of the panels vertical.

16. The apparatus of claim 15 in which the sill brackets are J-brackets that fit over the tops and under the bottoms of hinged doors to strengthen the doors, selectively deploy hurricane protection panels to cover and protect any glazing in the door, and to avoid obstructing ingress and egress using the door when the hurricane shutters are deployed.

17. The apparatus of claim 15 in which the doors are one of hinged doors and sliding glass doors.

18. The apparatus of claim 14 in which the sill brackets are deployed at the left and right of sliding glass doors making the orientation of the panels horizontal.

19. The apparatus of claim 14 in which the apparatus further complies with the Florida Building Code 2001 Nonhigh Velocity Hurricane Zones.

20. The apparatus of claim 14 in which the apparatus further achieves Large Missile Impact Resistance in conformance with ASTM-E 1886-97, 1996-99.

21. The apparatus of claim 14 in which the apparatus further complies with the uniform load structural test ASTM E-330.

22. A storm shutter apparatus for use with conventional fenestration products that are unmodified for I.B.C. compliance and which are installed at original wood frame building construction having wall studs covered by a substrate to which is applied a vapor barrier, the apparatus comprising:
a simple cross section header bracket including a window element ridge installed with a fin window, the window element ridge being disposed tightly against and sealed using seam seal tape to the vapor barrier preventing any rain water from reaching the top of the fin window by forcing rain water away from the top of the window in the manner of a rain hood;
a simple cross section sill bracket having a recessed bolt head track; and
isosceles trapezoidal corrugated shutter panels to be selectively attached to the header and sill brackets for storm protection, which together render a building aperture I.B.C. compliant.
